(19) United States
(12) Patent Application Publication
(10) Pub. No.: US 2015/0089457 A1
(43) Pub. Date: Mar. 26, 2015

(54) Hierarchical Approach to Triple Patterning Decomposition

(71) Applicant: International Business Machines Corporation, Armonk, NY (US)

(72) Inventors: Kanak B. Agarwal, Austin, TX (US); Lars W. Liebmann, Poughquag, NY (US)

(73) Assignee: International Business Machines Corporation, Armonk, NY (US)

(21) Appl. No.: 14/037,587

(22) Filed: Sep. 26, 2013

(51) Int. Cl. G06F 17/50

(52) U.S. Cl. CPC G06F 17/5081; G06F 2217/12; G06F 2217/06
USPC 716/52

(57) ABSTRACT

A mechanism is provided in a data processing system for hierarchical triple patterning decomposition. The mechanism receives an integrated circuit design. The mechanism enforces boundary conditions on three-color mapping of shapes in a layer of the integrated circuit design at the cell level. The mechanism places cells in the layer of the integrated circuit design. The mechanism identifies post placement coloring conflicts and resolves the post placement coloring conflicts with two-color flipping in coloring runs containing one or more conflicts.

### BACKGROUND

The present application relates generally to an improved data processing apparatus and method and more specifically to mechanisms for a hierarchical approach to triple patterning decomposition.

Optical lithography is a crucial step in semiconductor manufacturing. The basic principle of optical lithography is quite similar to that of chemistry-based photography. The images of the patterned photo-mask are projected through the high-precision optical system onto the wafer surface, which is coated with a layer of light-sensitive chemical compound, e.g. photo-resist. The patterns are then formed on the wafer surface after complex chemical reactions and follow-on manufacturing steps, such as development, post-exposure bake, and wet or dry etching.

Multiple patterning is a class of technologies developed for photolithography to enhance the feature density. The simplest case of multiple patterning is double patterning, where a conventional lithography process is enhanced to produce double the expected number of features. Double exposure is a sequence of two separate exposures of the same photoresist layer using two different photomasks. This technique is commonly used for patterns in the same layer which have incompatible densities or pitches. In one important case, the two exposures may each consist of lines which are oriented in one or the other of two usually perpendicular directions. This allows the decomposition of two-dimensional patterns into two one-dimensional patterns which are easier to print.

Double pattern lithography (DPL) is an effective technique to improve resolution. DPL theoretically doubles resolution through pitch splitting such that effective pitch of the layout for each patterning step is halved. DPL involves two separate exposures and etch/freeze steps (litho-etch-litho-etch or litho-freeze-litho-etch). DPL is expected to be needed for 20 nm. technology and is one of the best candidate solutions for scaling to 14 nm technology and beyond.

For one-dimensional patterns at minimum pitch, layout decomposition for double patterning is trivial. Decomposition is very complex for more complicated two-dimensional patterns. DPL layout decomposition solutions typically cast layout decomposition as a graph coloring problem where two features less than a certain minimum spacing must be assigned different colors. DPL decomposition is very challenging to implement at the full-chip level when stitch insertion is considered. A stitch insertion in a polygon during decomposition indicates that one part of the polygon will be printed in the first patterning step while the remaining part of the polygon will be printed using second patterning, with the two parts joining together at the stitch location. Stitches can help in removing some decomposition conflicts but they can potentially break a polygon into multiple pieces. Conflicts that cannot be removed with stitch insertion require layout modification (sometimes major), which can be very challenging and costly (increase layout area). As a result, considering all candidate stitch insertion locations during layout decomposition is crucial to take full advantage of stitching capability.

### SUMMARY

In one illustrative embodiment, a method, in a data processing system, is provided for hierarchical triple patterning decomposition. The method comprises receiving an integrated circuit design. The method further comprises enforcing boundary conditions on three-color mapping of shapes in a layer of the integrated circuit design at the cell level. The method further comprises placing cells in the layer of the integrated circuit design. The method further comprises identifying post placement coloring conflicts and resolving the post placement coloring conflicts with two-color flipping in coloring runs containing one or more conflicts.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is a block diagram of an example data processing system in which aspects of the illustrative embodiments may be implemented;

FIGS. 2A and 2B illustrate the difference between a three-color solution and a two-color solution;

FIGS. 3A and 3B illustrate the difference between a three-color solution and a two-color solution for advanced nodes;

FIG. 4 illustrates an example three-color mapping for an advanced design;

FIG. 5 is a flowchart illustrating operation of a mechanism for hierarchical triple patterning decomposition in accordance with an illustrative embodiment;

FIGS. 6A and 6B illustrate an implementation example for a metal layer with a clean cell-level check in accordance with an illustrative embodiment;

FIGS. 7A and 7B illustrate an implementation example for a metal layer with a bad cell-level check in accordance with an illustrative embodiment;

FIGS. 8A and 8B illustrate an implementation example for a metal layer with a corrected cell-level check in accordance with an illustrative embodiment;

FIGS. 9A and 9B illustrate post-placement checks for an implementation example in accordance with an illustrative embodiment;

FIGS. 10A and 10B illustrate an implementation example for an interconnect layer with a clean cell-level check in accordance with an illustrative embodiment;

FIGS. 11A and 11B illustrate an implementation example for an interconnect layer with a bad cell-level check in accordance with an illustrative embodiment;

FIGS. 12A and 12B illustrate an implementation example for an interconnect layer with a corrected cell-level cheek in accordance with an illustrative embodiment; and

FIGS. 13A and 13B illustrate an implementation example of an interconnect layer with post-placement checks in accordance with an illustrative embodiment.

### DETAILED DESCRIPTION

The illustrative embodiments provide a hierarchical approach to triple patterning decomposition. As the rate of semiconductor scaling continues to outpace the introduction of higher resolution exposure systems, the microelectronics industry is being forced to adopt double and triple patterning lithography solutions. For technology nodes where the required feature pitch exceeds the available lithography resolution, double patterning (DP) achieves the desired on-wafer resolution by interdigitating two optically decoupled exposures, each of which is above the resolution limit of the lithography tool.

Because double patterning requires the layout to be split into two masks, it is necessary that layouts are “two-color mappable,” each color representing a unique mask. It is very easy to construct circuit design relevant layouts that cannot be two-color mapped following a simple set of rules (opposite color space=x, same color space=2x). To prevent designers from creating un-decomposable layouts, two-color mapping has to be embedded into the design rule checking (DRC) flow.

The challenge with decomposition checks as part of DRC is that two-color mapping is a global problem affecting all shapes in a cluster defined by a chain of shapes linked by a minimum space requiring a color transition. Reporting color violations to the designers as the result of the checking is misleading, because it reduces the decomposition error to a pairwise conflict when in reality multiple shapes interact to form the conflict, and because multiple shapes are available to resolve the conflict. Any one interaction in the odd cycle can be broken to fix the odd cycle and make the layout decomposable.

An alternative approach for resolving odd-cycle conflicts in double patterning is to introduce a third color, exercising the same process described above with three exposure steps instead of two. The availability of a third color helps resolve simple odd cycles. However, more complex layouts can exhibit color conflicts even with three colors. Thus, a need arises for a checking solution that provides designers with the same degree of actionable feedback as the odd-cycle reporting does in two-color mapping.

Three-color mapping is NP-complete (nondeterministic polynomial time complete); color coding requires a combination of heuristics and advanced algorithms. Conflict reporting is non-trivial and requires a color-graph analysis to identify un-colorable sub-graphs (e.g., an odd collection of triangles).

Complex color dependencies prevent efficient hierarchy management. In double patterning, hierarchical layout coloring is enabled by black-boxing the details of a particular color run and only communicating the relative coloring of the end-points or boundaries to the next level of the hierarchy. Due to the large number of possible color combinations in triple patterning, the color constraints of the next level of the hierarchy cannot be reduced to simple boundary conditions for the next level of the hierarchy, resulting in significant data flattening and unacceptable data volume increase. The illustrative embodiments provide a solution to the latter problem of efficient hierarchical design.

The illustrative embodiments enable hierarchical designs for triple patterning by enforcing boundary conditions at the lowest level of the hierarchy (e.g., the cell level in a standard cell layout) such that all color conflicts at higher levels of the hierarchy are reduced to a two-color mapping problem. The cell level of a hierarchical design uses all three colors to obtain maximum feature placement density, but boundary conditions enforced at the cell level ensure that all inter-cell color interactions can be treated as two-color interactions and can be resolved through two-color “flipping.”

The above aspects and advantages of the illustrative embodiments of the present invention will be described in greater detail hereafter with reference to the accompanying figures. It should be appreciated that the figures are only intended to be illustrative of exemplary embodiments of the present invention. The present invention may encompass aspects, embodiments, and modifications to the depicted exemplary embodiments not explicitly shown in the figures but would be readily apparent to those of ordinary skill in the art in view of the present description of the illustrative embodiments.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be a system, apparatus, or device of an electronic, magnetic, optical, electromagnetic, or semiconductor nature, any suitable combination of the foregoing, or equivalents thereof. More specific examples (a non-exhaustive list) of the computer readable storage medium would include the following: an electrical device having a storage capability, a portable computer diskette, a hard disk, a random access memory (RAM), a read-only memory (ROM), an erasable programmable read-only memory (EPROM or Flash memory), an optical fiber based device, a portable compact disc read-only memory (CDROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

In some illustrative embodiments, the computer readable medium is a non-transitory computer readable medium. A non-transitory computer readable medium is any medium that is not a disembodied signal or propagation wave, i.e. pure signal or propagation wave per se. A non-transitory computer readable medium may utilize signals and propagation waves, but is not the signal or propagation wave itself. Thus, for example, various forms of memory devices, and other types of systems, devices, or apparatus, that utilize signals in any way, such as, for example, to maintain their state, may be considered to be non-transitory computer readable media within the scope of the present description.

A computer readable signal medium, on the other hand, may include a propagated data signal with computer readable program code embodied therein, for example, in a baseband or as part of a carrier wave, Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Similarly, a computer readable storage medium is any computer readable medium that is nota computer readable signal medium.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

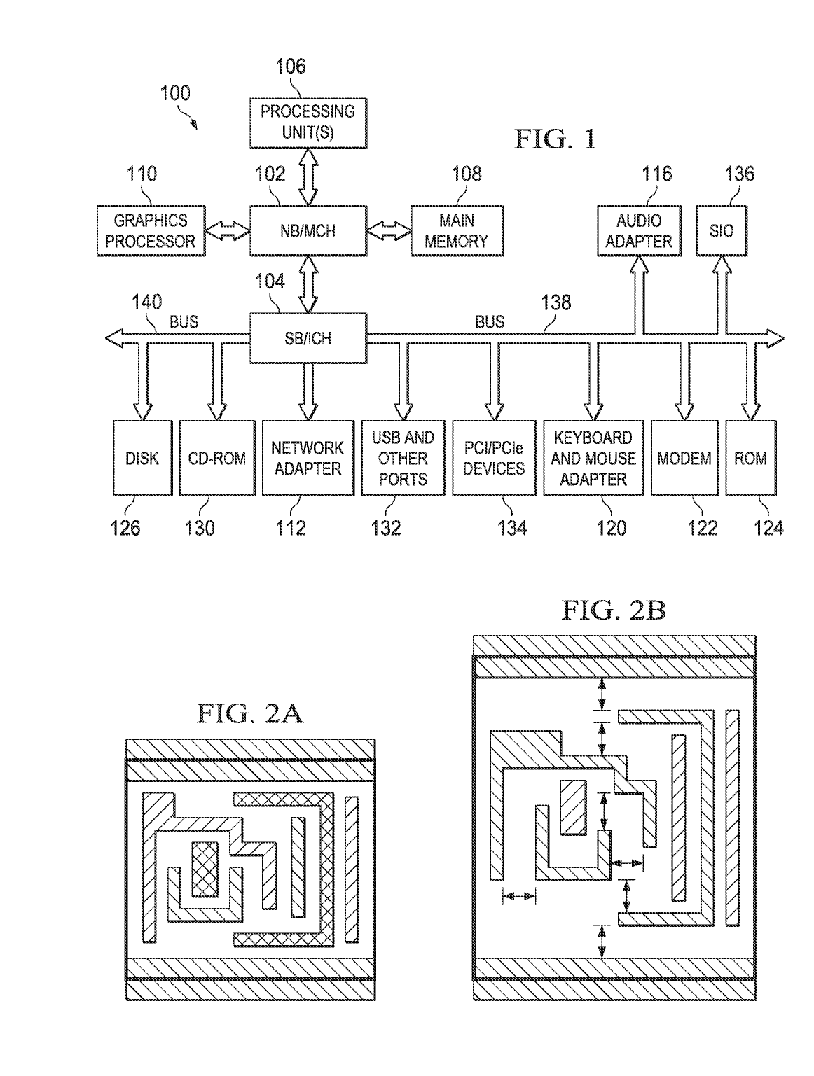

The illustrative embodiments may be utilized in many different types of data processing environments. In order to provide a context for the description of the specific elements and functionality of the illustrative embodiments, FIG. 1 is provided hereafter as an example environment in which aspects of the illustrative embodiments may be implemented. It should be appreciated that FIG. 1 is only an example and is not intended to assert or imply any limitation with regard to the environments in which aspects or embodiments of the present invention may be implemented. Many modifications to the depicted environments may be made without departing from the spirit and scope of the present invention.

FIG. 1 is a block diagram of an example data processing system in which aspects of the illustrative embodiments may be implemented. Data processing system 100 is an example of a computer in which computer usable code or instructions implementing the processes for illustrative embodiments of the present invention may be located.

In the depicted example, data processing system 100 employs a hub architecture including north bridge and memory controller huh (NB/MCH) 102 and south bridge and input/output (I/O) controller hub (SB/ICH) 104. Processing unit 106, main memory 108, and graphics processor 110 are connected to NB/MCH 102. Graphics processor 110 may be connected to NB/MCH 102 through an accelerated graphics port (AGP).

In the depicted example, local area network (LAN) adapter 112 connects to SB/ICH 104. Audio adapter 116, keyboard and mouse adapter 120, modem 122, read only memory (ROM) 124, hard disk drive (HDD) 126, CD-ROM drive 130, universal serial bus (USB) ports and other communication ports 132, and PCI/PCIe devices 134 connect to SB/ICH 104 through bus 138 and bus 140. PCI/PCIe devices may include, for example, Ethernet adapters, add-in cards, and PC cards for notebook computers. PCI uses a card bus controller, while PCIe does not. ROM 124 may be, for example, a flash basic input/output system (BIOS).

HDD 126 and CD-ROM drive 130 connect to SB/ICH 104 through bus 140. HDD 126 and CD-ROM drive 130 may use, for example, an integrated drive electronics (IDE) or serial advanced technology attachment (SATA) interface. Super I/O (SIO) device 136 may be connected to SB/ICH 104.

An operating system runs on processing unit 106. The operating system coordinates and provides control of various components within the data processing system 100 in FIG. 1. As a client, the operating system may be a commercially available operating system such as the Microsoft® Windows 7® operating system. An object-oriented programming system, such as the Java™ programming system, may run in conjunction with the operating system and provides calls to the operating system from Java™ programs or applications executing on data processing system 100.

As a server, data processing system 100 may be, for example, an IBM® eServer™ System p® computer system, running the Advanced Interactive Executive (AIX®) operating system or the LINUX® operating system. Data processing system 100 may be a symmetric multiprocessor (SMP) system including a plurality of processors in processing unit 106. Alternatively, a single processor system may be employed.

Instructions for the operating system, the object-oriented programming system, and applications or programs are located on storage devices, such as HDD 126, and may be loaded into main memory 108 for execution by processing unit 106. The processes for illustrative embodiments of the present invention may be performed by processing unit 106 using computer usable program code, which may be located in a memory such as, for example, main memory 108, ROM 124, or in one or more peripheral devices 126 and 130, for example.

A bus system, such as bus 138 or bus 140 as shown in FIG. 1, may be comprised of one or more buses. Of course, the bus system may be implemented using any type of communication fabric or architecture that provides for a transfer of data between different components or devices attached to the fabric or architecture. A communication unit, such as modem 122 or network adapter 112 of FIG. 1, may include one or more devices used to transmit and receive data. A memory may be, for example, main memory 108, ROM 124, or a cache such as found in NB/MCH 102 in FIG. 1.

Those of ordinary skill in the art will appreciate that the hardware in FIG. 1 may vary depending on the implementation. Other internal hardware or peripheral devices, such as flash memory, equivalent non-volatile memory, or optical disk drives and the like, may be used in addition to or in place of the hardware depicted in FIG. 1. Also, the processes of the illustrative embodiments may be applied to a multiprocessor data processing system, other than the SMP system mentioned previously, without departing from the spirit and scope of the present invention.

Moreover, the data processing system 100 may take the form of any of a number of different data processing systems including client computing devices, server computing devices, a tablet computer, laptop computer, telephone or other communication device, a personal digital assistant (PDA), or the like. In some illustrative examples, data processing system 100 may be a portable computing device that is configured with flash memory to provide non-volatile memory for storing operating system files and/or user-generated data, for example. Essentially, data processing system 100 may be any known or later developed data processing system without architectural limitation.

FIGS. 2A and 2B illustrate the difference between a three-color solution and a two-color solution. More particularly, FIG. 2A illustrates a three-color solution for a design of a multiplexer. As shown, the three-color solution decomposes the features into three colors without violating any minimum spacing rules.

Turning to FIG. 2B, a two-color solution for the multiplexer design is shown. With the two-color solution, features must be moved to conform to minimum spacing rules, resulting in a much tower feature density. The design of FIG, 2A with three-color decomposition may result in a multiplexer that is 0.48 μm×0.432 μm, while the design of FIG. 2B with two-color decomposition may result in a multiplexer that is 0.56 μm×0.652 μm. The two-color solution results in an unacceptable feature density.

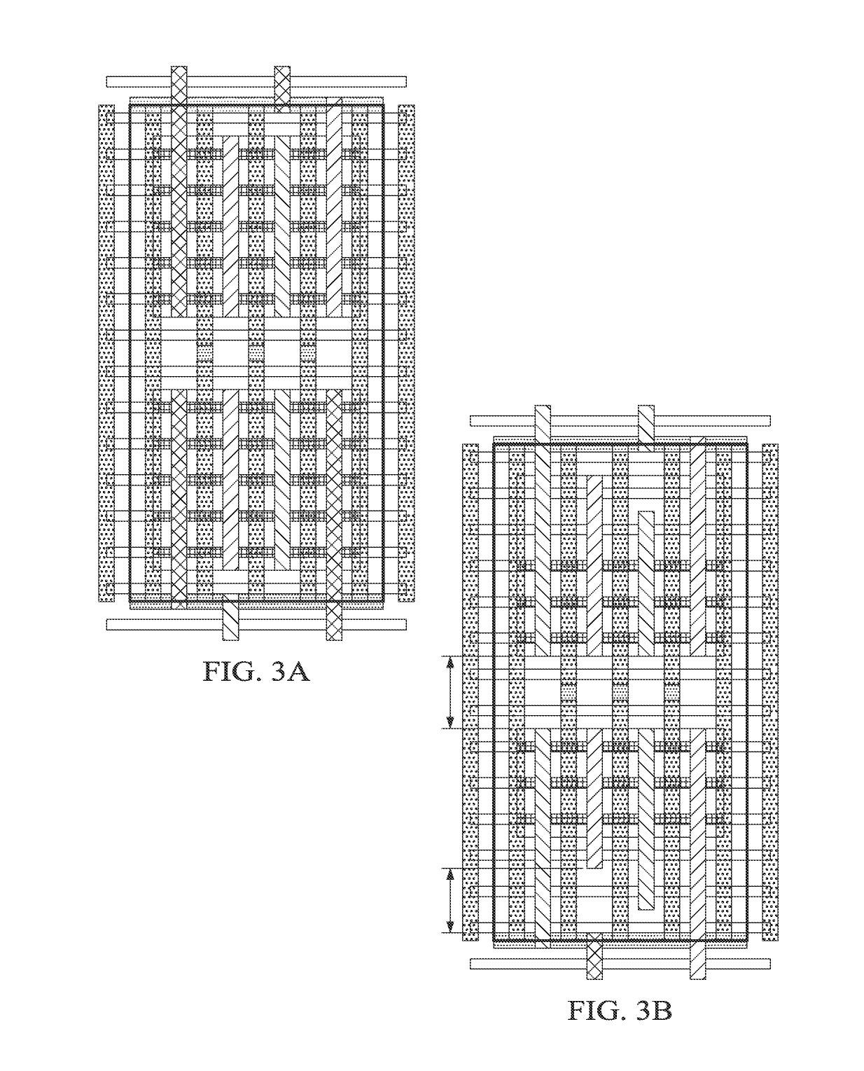

FIGS. 3A and 3B illustrate the difference between a three-color solution and a two-color solution for advanced nodes. FIG. 3A illustrates an example advanced node with three-color decomposition. The three-color solution results in a standard cell tin efficiency (i.e., active fins/total fins) of 10/14.

FIG. 3B illustrates an example node with two-color composition. Due to same-color spacing rules, the two-color solution results in moving features to avoid conflicts. The two-color solution results in a standard cell fin efficiency (i.e., active fins/total fins) of 6/14. Thus, the two-color solution results in an unacceptable performance hit.

Therefore, it is important to develop a hierarchical triple patterning design methodology. Three-color mapping is NP-complete. Coloring solutions rely heavily on heuristics that break on very large clusters of shapes, Three-color mapping does not lend itself to hierarchical coloring. In two-color mapping, data hierarchy is preserved through sequential color-flipping operations. The presence of the third color makes this impossible.

As in two-color mapping, design efficiency dictates that any potential post-placement color conflicts can be anticipated and prevented at the cell level design. Conservative “exclusion zones” around the cell boundaries are possible for some design levels (e.g., first metal, M1) but have significant density impact if enforced indiscriminately. For some design levels (e.g., local interconnect, CA), conservative exclusion zones around the cell boundary are not an option because shapes have to interact across the cell boundary (i.e., power traps in a shared power rail).

It is therefore a goal of the illustrative embodiments to provide a design methodology that fully utilizes the additional density afforded by triple patterning and enforces boundary conditions on three-color mapping at the cell level to ensure that post placement color conflicts can be resolved. The illustrative embodiments may resolve these conflicts with simple two-color flipping (i.e., all three-color mapping is contained at the cell level) and without the possibility of introducing “odd cycles” that would require further layout correction.

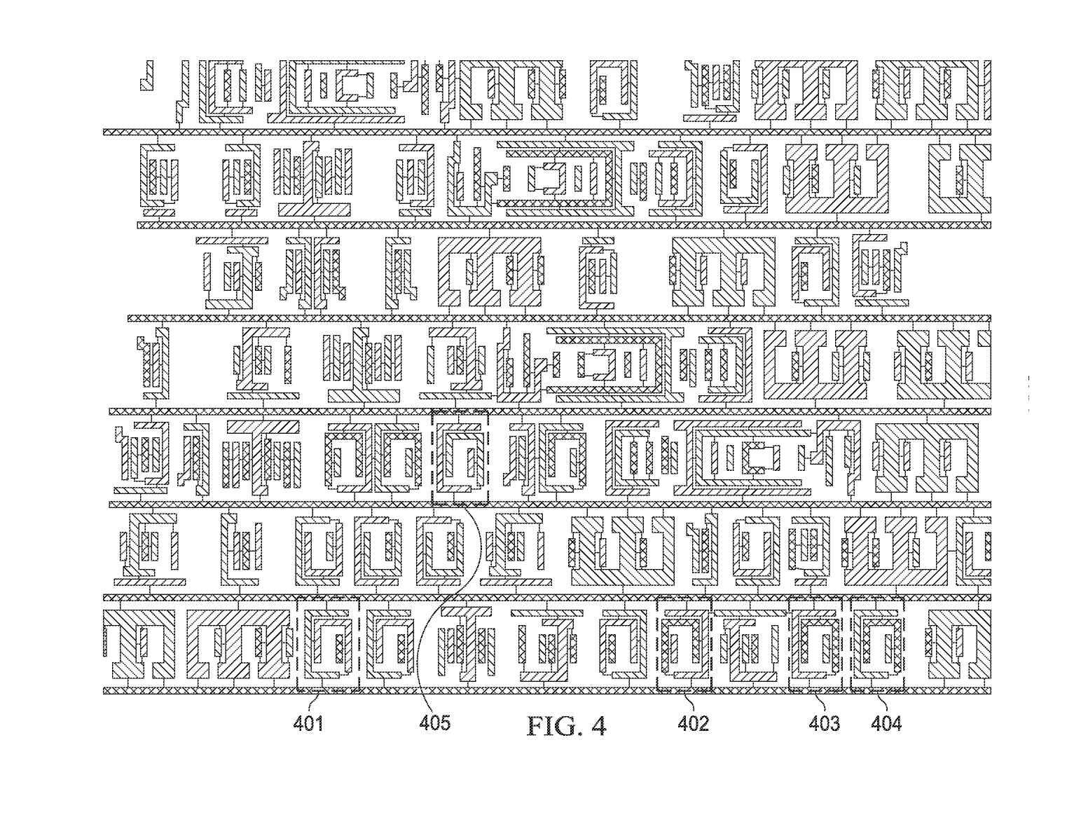

FIG. 4 illustrates an example three-color mapping for an advanced design. An unconstrained three-color mapping after placement results in a significant data explosion. Note cells 401-405 represent a simple cell in this example, but result in at least five unique coloring solutions.

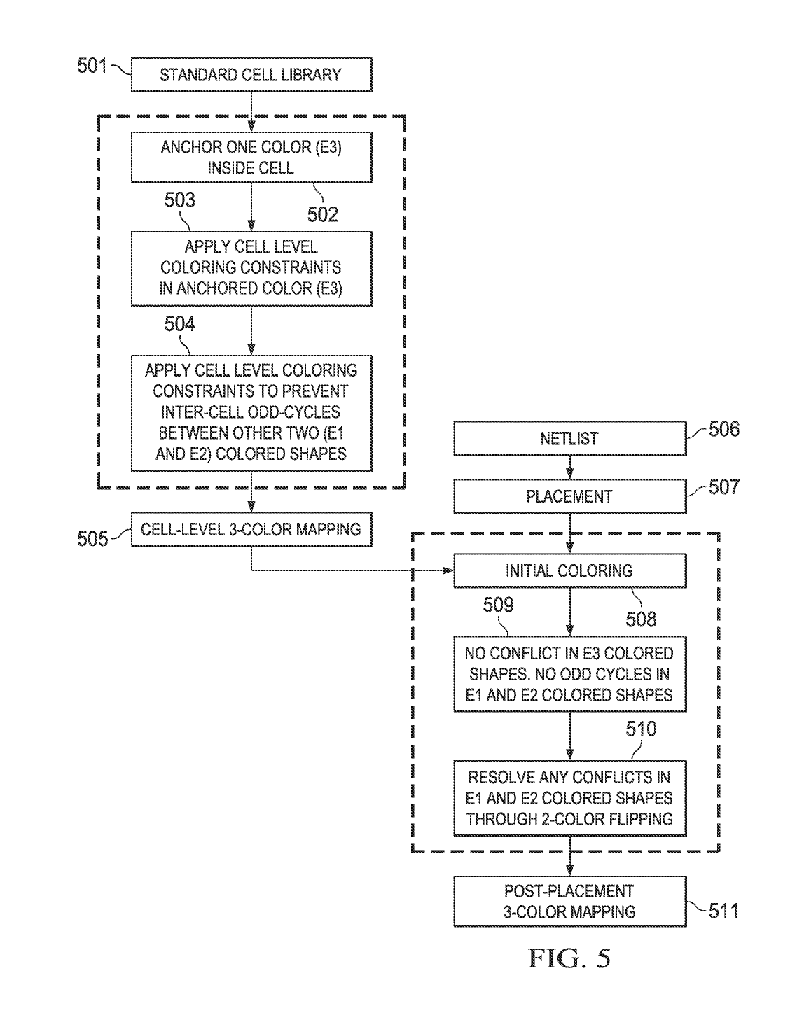

FIG. 5 is a flowchart illustrating operation of a mechanism for hierarchical triple patterning decomposition in accordance with an illustrative embodiment. Operation begins with a standard cell library in block 501. The mechanism anchors one color (E3) inside the cell (block 502). The mechanism applies cell level coloring constraints to prevent inter-cell conflicts in the anchored color (E3) (block 503). The mechanism then applies cell level coloring constraints to prevent inter-cell odd-cycles between other two (E1 and E2) colored shapes. The mechanism performs blocks 502-504 for each cell in the cell library in a first level of the hierarchy. The mechanism then performs cell-level three-color mapping (block 505).

Operation also begins with a netlist for an integrated circuit (IC) design in block 506. The mechanism performs placement of shapes in the IC design (block 507). The mechanism then performs initial coloring (block 508) using the three-color mapping from block 505. The mechanism ensures no conflict in E3 colored shapes and no odd-cycles in E1 and E2 colored shapes (block 509). The mechanism resolves any conflicts in E1 and E2 colored shapes using two-color flipping (block 510). The mechanism performs blocks 508-510 in a second level of the hierarchy. The mechanism then performs post-placement three-color mapping for the IC design (block 511), and operation ends.

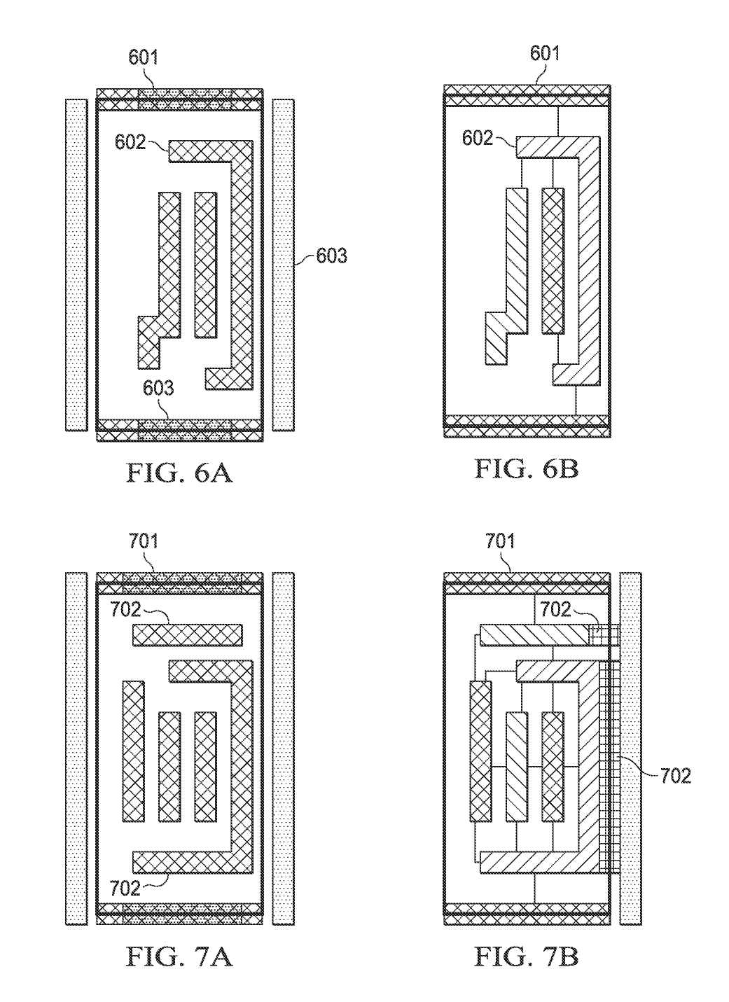

FIGS. 6A and 6B illustrate an implementation example for a metal layer with a clean cell-level check in accordance with an illustrative embodiment, FIG. 6A illustrates the example implementation for M1 layer before decomposition. The mechanism of the illustrative embodiments applies M1 cell-level boundary conditions. The horizontal boundary 601 (i.e., shared power rail) is fixed at one color (M1_E3). The vertical boundary 602 is restricted to one color that is not M1_E3 (i.e., either entirely M1_E1 or entirely M1_E2). The mechanism also generates support shapes 603 to enforce boundary conditions. FIG. 6B illustrates the example implementation for M1 layer after decomposition.

FIGS. 7A and 7B illustrate an implementation example for a metal layer with a bad cell-level check in accordance with an illustrative embodiment. FIG. 7A illustrates the example implementation for M1 layer before decomposition. The horizontal boundary 701 (i.e., shared power rail) is fixed at one color (M1_E3). The vertical boundary 702 is restricted to one color that is not M1_E3 (i.e., either entirely M1_E1 or entirely M1_E2). The vertical boundary condition is violated requiring a layout correction. FIG. 7B illustrates the example implementation for M1 layer after decomposition.

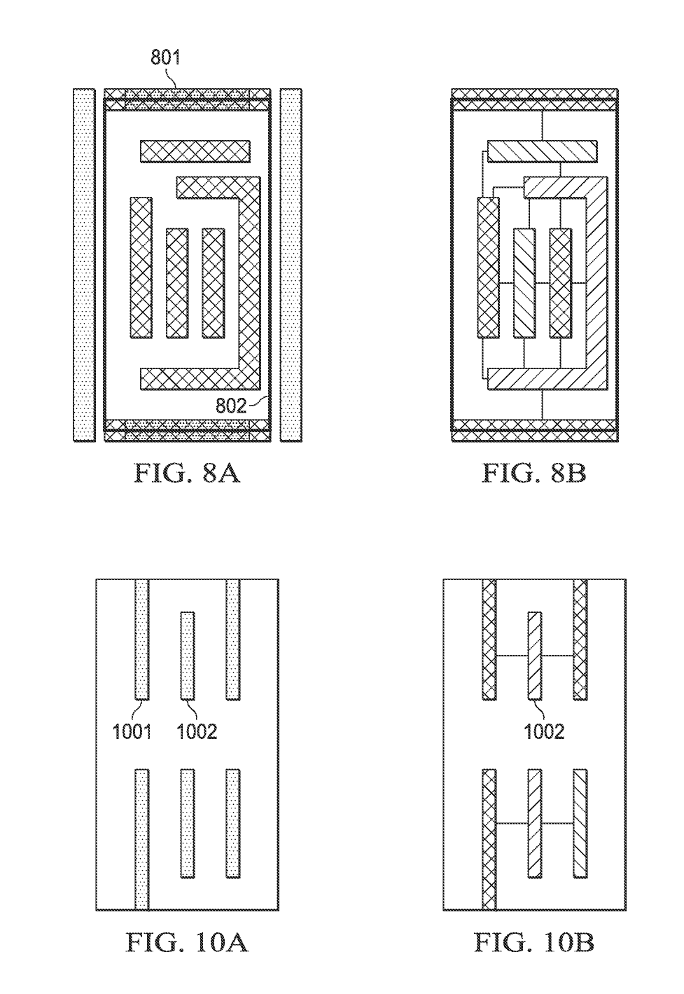

FIGS. 8A and 8B illustrate an implementation example for a metal layer with a corrected cell-level check in accordance with an illustrative embodiment. FIG. 8A illustrates the example implementation for M1 layer before decomposition. The horizontal boundary 801 (i.e., shared power rail) is fixed at one color (M1_E3). The vertical boundary 802 is restricted to one color that is not M1_E3 (i.e., either entirely M1_E1 or entirely M1_E2). A minor adjustment corrects the layout to avoid the boundary condition violation. FIG. 8B illustrates the example implementation for M1 layer after decomposition.

FIGS. 9A and 9B illustrate post-placement checks for an implementation example in accordance with an illustrative embodiment. As seen in FIG. 9A, cells following the boundary conditions after placement show cell-to-cell conflicts 901. FIG. 9B shows the implementation after two-color flipping of the affected color runs. Note the mechanism cannot simply flip the color of the pair of shapes in conflict. The mechanism must recolor the entire “run” (i.e., all color-connected shapes) that is affected by the conflict. However, this is now a two-color mapping problem rather than a three-color mapping problem.

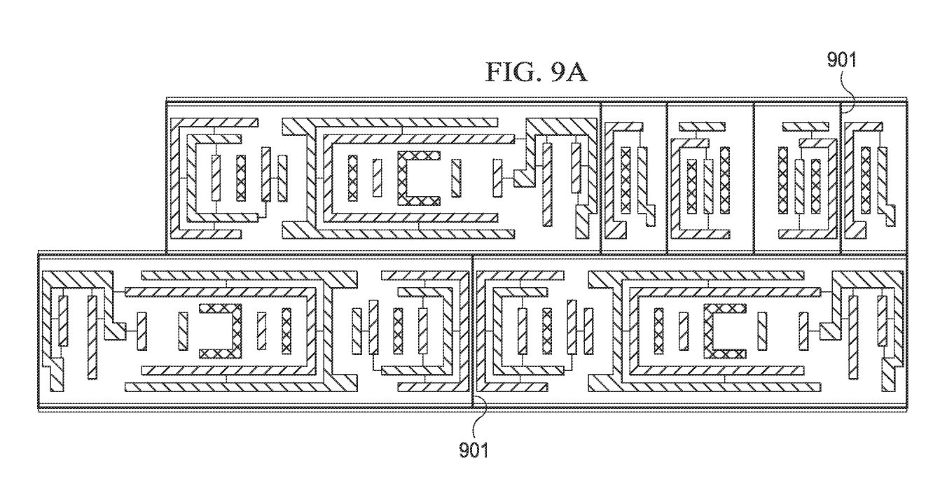

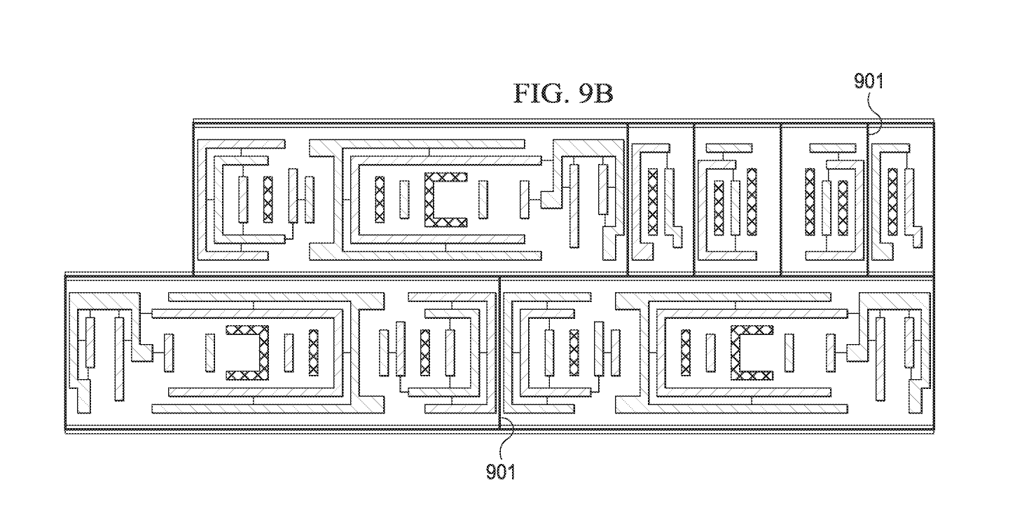

FIGS. 10A and 10B illustrate an implementation example for an interconnect layer with a clean cell-level check in accordance with an illustrative embodiment. FIG. 10A illustrates the interconnect layer implementation before decomposition. Shapes 1001 that touch the cell boundary are fixed at one color (CA_E3). Shapes that do not touch the cell boundary are restricted to be either CA_E1 or CA_E2 and not CA_E3. Shape 1002, which is next to a shape that touches the boundary, is fixed at CA_E2. FIG. 10B illustrates the interconnect layer implementation after decomposition.

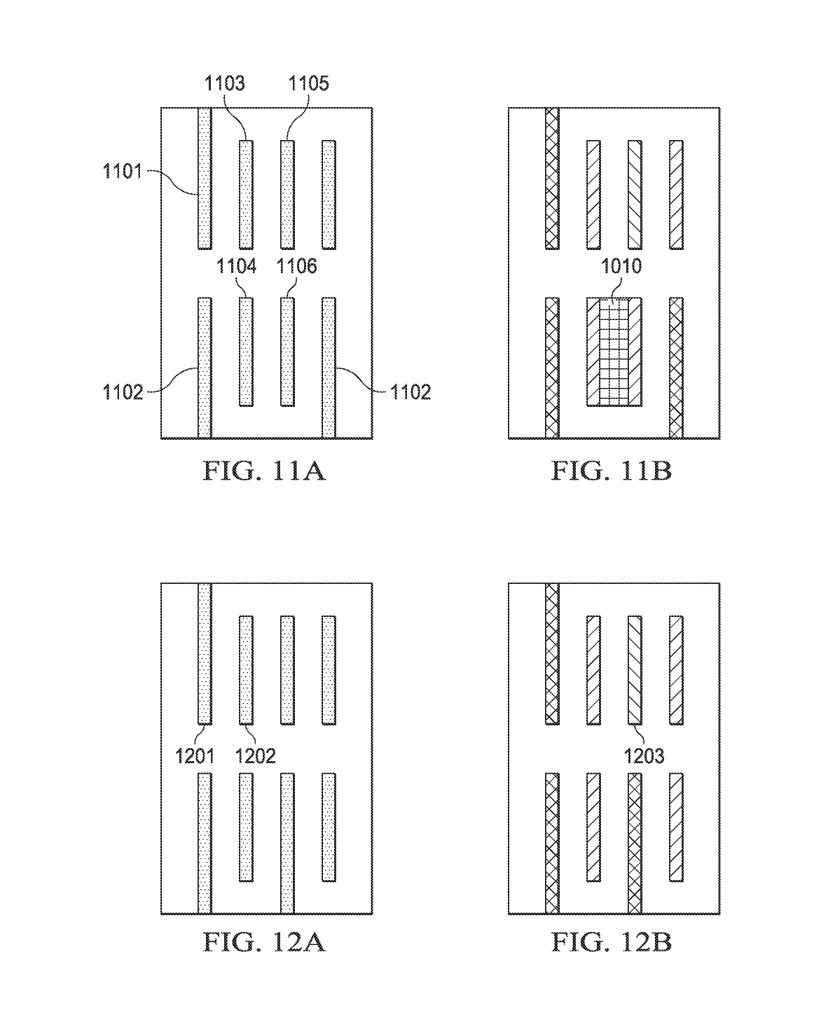

FIGS. 11A and 11B illustrate an implementation example for an interconnect layer with a bad cell-level check in accordance with an illustrative embodiment. FIG. 11A illustrates the interconnect layer implementation before decomposition. Shapes 1101 and 1102 that touch the cell boundary are fixed at one color (CA_E3). Shapes that do not touch the cell boundary are restricted to be either CA_E1 or CA_E2 and not CA_E3. Shapes 1103-1106, which are next to a shape that touches the boundary, are fixed at CA_E2. FIG. 11B illustrates the interconnect layer implementation after decomposition. Boundary conditions cause an internal color conflict (i.e. same-color space violation), which requires a layout change 1010 to correct the conflict.

FIGS. 12A and 12B illustrate an implementation example for an interconnect layer with a corrected cell-level check in accordance with an illustrative embodiment. FIG. 12A illustrates the interconnect layer implementation before decomposition. Shapes 1201 that touch the cell boundary are fixed at one color (CA_E3). Shapes that do not touch the cell boundary are restricted to be either CA_E1 or CA_E2 and not CA_E3. Shape 1202, which is next to a shape that touches the boundary, is fixed at CA_E2. FIG. 12B illustrates the interconnect layer implementation after decomposition. As seen in FIG. 12B, shape 1203 is given color CA_E1 to avoid an internal conflict.

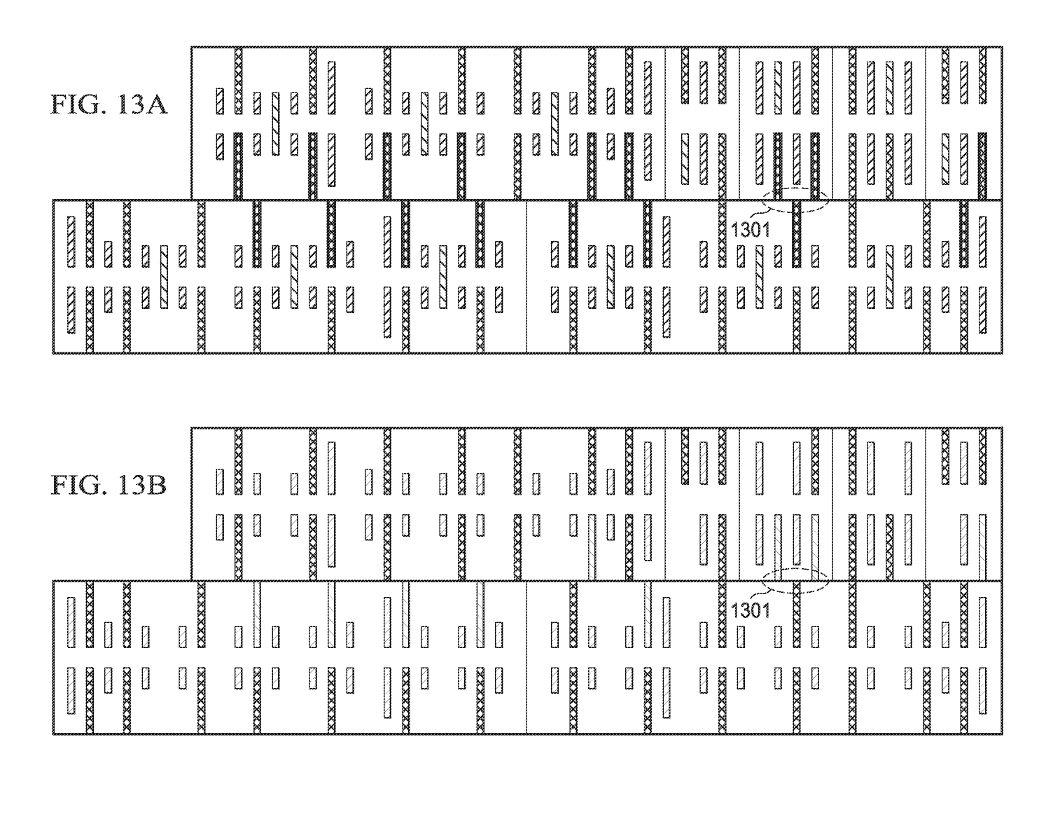

FIGS. 13A and 13B illustrate an implementation example of an interconnect layer with post-placement checks in accordance with an illustrative embodiment. As seen in FIG. 13A, cells following the boundary conditions after placement show cell-to-cell conflicts 1301. FIG. 13B shows the implementation after two-color flipping of the affected color runs. Note some “runs” include more than two shapes, but due to the boundary conditions, this is now a simple two-color mapping problem rather than a three-color mapping problem.

Thus, the illustrative embodiments provide mechanisms for hierarchical triple patterning decomposition. The mechanism implements boundary conditions that contain three-color mapping at the cell level while reducing all inter-cell color interactions to two-color mapping problems for which hierarchical solutions exist.

In one implementation, the mechanism forces non-branching inter-cell color runs. While the color dependencies inside the cell can involve three colors and a complex array of multi-body color interactions, the key is that all of the complexity can be hidden from the next level of the hierarchy by reducing the cell to a “black box.” Forcing one pair of cell boundaries (e.g., the horizontal edges) for which shapes are shared between abutting cells to permanently assume a predetermined color constrains the intra-cell coloring run to be unidirectional (i.e., only along rows of cells, not across rows). A second set of boundary conditions for the vertical edges ensures that the intra-cell coloring run has no branches, which could lead to odd-cycles (i.e., single color per edge) and it ensures that intra-cell conflicts can be resolved by flipping the two remaining colors that are not used on the horizontal boundary.

In another implementation, the cell-level boundary conditions ensure a non-propagating localized two-color flipping solution after cell placement. Enforcing the boundary conditions ensures that all intra-cell conflicts can be resolved by two-color flipping to eliminate localized “odd-cycles.”

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or IO devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Moderns, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated,

What is claimed is:

1. A method, in a data processing system, for hierarchical triple patterning decomposition, the method comprising:
receiving an integrated circuit design;
enforcing boundary conditions on three-color mapping of shapes in a layer of the integrated circuit design at the cell level;
placing cells in the layer of the integrated circuit design;
identifying post placement coloring conflicts; and
resolving the post placement coloring conflicts with two-color flipping in coloring runs containing one or more conflicts.

2. The method of claim 1, wherein enforcing boundary conditions comprises:
anchoring one color inside a given cell;
applying cell-level boundary conditions to prevent inter-cell conflicts in the anchored color; and
applying cell-level coloring constraints to prevent inter-cell odd-cycles between non-anchored color shapes.

3. The method of claim 2, wherein the layer is a metal layer and wherein the anchored color is a color assigned to power rail shapes.

4. The method of claim 2, wherein the layer is a local interconnect layer and wherein the anchored color is a color assigned to shapes that touch the cell boundary.

5. The method of claim 1, wherein enforcing boundary conditions comprises:
fixing a horizontal boundary at a first color; and
fixing a vertical boundary at a second color.

6. The method of claim 5, wherein enforcing boundary conditions further comprises:
generating support shapes to enforce boundary conditions.

7. The method of claim 5, wherein enforcing boundary conditions comprises:
performing a layout adjustment to correct a boundary condition violation in the cell.

8. The method of claim 1, wherein enforcing boundary conditions comprises:
assigning a first color to shapes that touch the cell boundary;
assigning a second color to shapes next to the shapes that touch the cell boundary; and
assigning the second color or a third color to other shapes within the cell.

9. The method of claim 1, wherein two color flipping comprises swapping a placed cell with a functionally equivalent but oppositely colored counterpart.

10. The method of claim 1, wherein resolving post placement coloring conflicts comprises combining two-color flipping with another conflict resolution technique.

11. The method of claim 10, wherein the another color resolution technique comprises cell mirroring or insertion of non-functional filler cells.

12. A computer program product comprising a computer readable storage medium having a computer readable program stored therein, wherein the computer readable program, when executed on a computing device, causes the computing device to:
receive an integrated circuit design;
enforce boundary conditions on three-color mapping of shapes in a layer of the integrated circuit design at the cell level;
place cells in the layer of the integrated circuit design;
identify post placement coloring conflicts; and
resolve the post placement coloring conflicts with two-color flipping in coloring runs containing one or more conflicts.

13. The computer program product of claim 12, wherein enforcing boundary conditions comprises:
anchoring one color inside a given cell;
applying cell-level boundary conditions to prevent inter-cell conflicts in the anchored color; and
applying cell-level coloring constraints o prevent inter-cell odd-cycles between non-anchored color shapes.

14. The computer program product of claim 13, wherein the layer is a metal layer and wherein the anchored color is a color assigned to power rail shapes.

15. The computer program product of claim 13, wherein the layer is a local interconnect layer and wherein the anchored color is a color assigned to shapes that touch the cell boundary.

16. The computer program product of claim 12, wherein enforcing boundary conditions comprises:
fixing a horizontal boundary at a first color; and
fixing a vertical boundary at a second color.

17. The computer program product of claim 12, wherein enforcing boundary conditions comprises:
assigning a first color to shapes that touch the cell boundary;
assigning a second color to shapes next to the shapes that touch the cell boundary; and
assigning the second color or a third color to other shapes within the cell.

18. An apparatus comprising:
a processor; and
a memory coupled to the processor, wherein the memory comprises instructions which, when executed by the processor, cause the processor to:
receive an integrated circuit design;
enforce boundary conditions on three-color mapping of shapes in a layer of the integrated circuit design at the cell level;
place cells in the layer of the integrated circuit design;
identify post placement coloring conflicts; and
resolve the post placement coloring conflicts with two-color flipping in coloring runs containing one or more conflicts.

19. The apparatus of claim 18, wherein enforcing boundary conditions comprises:
anchoring one color inside a given cell;
applying cell-level boundary conditions to prevent inter-cell conflicts in the anchored color; and
applying cell-level coloring constraints to prevent inter-cell odd-cycles between non-anchored color shapes.

20. The apparatus of claim 19, wherein the layer is a metal layer and wherein the anchored color is a color assigned to power rail shapes.

21. The apparatus of claim 19, wherein the layer is a local interconnect layer and wherein the anchored color is a color assigned to shapes that touch the cell boundary.
